(19) United States
(12) Patent Application Publication
(10) Pub. No.: US 2025/0187111 A1
(43) Pub. Date: Jun. 12, 2025

(54) ROUND KNIFE DISCHARGE MOLDS FOR LASER CUTTING

(71) Applicant: Manaflex, LLC, Waikoloa, HI (US)

(72) Inventor: Robert C. Lane, Las Vegas, NV (US)

(21) Appl. No.: 18/976,684

(22) Filed: Dec. 11, 2024

Related U.S. Application Data
(60) Provisional application No. 63/608,854, filed on Dec. 12, 2023.

(51) Int. Cl. B23K 26/142; B23K 26/38; B23K 26/70

(52) U.S. Cl. CPC B23K 26/142; B23K 26/38; B23K 26/702

(57) ABSTRACT

A round knife waste discharge mold for laser cutting that uses air to remove waste. The mold has an overall cylindrical configuration and the shape of the mold is referred to as being round or circular, which is indicative of the cross-sectional shape of the mold. In one embodiment, the mold comprises a round knife mold that has a number of profiled top blocks protruding from its circumference or circumferential surface, and a number of air blow holes are provided in the profiled top blocks.

### CROSS-REFERENCE TO RELATED APPLICATION

This application is a non-provisional application of, and claims priority to and the benefit of, U.S. Provisional Patent App. No. 63/608,854, entitled “Rough Knife Discharge Molds For Laser Cutting”, filed Dec. 12, 2023, with Attorney Docket No. 4375.0006C, the entire disclosure of which is incorporated by reference herein in its entirety.

### TECHNICAL FIELD

The invention relates to the field of sheet processing equipment, and more particularly, relates to a round knife waste discharge mold for laser cutting.

### BACKGROUND

Laser die cutting machines are a new type of high-efficiency die cutting machine. The machines involve a feeding laminating module from which material layer is transferred to a laser die cutting module, where a laser head is used to cut the material layer. In the die cutting process, the final step should be the removal or exclusion from the finished product of any waste product. In some processes, an auxiliary film paste is separated as waste, and this results in the exclusion of more than 0.25 mm metal waste. Sometimes, due to the thickness and hardness of raw materials, there may be more waste that cannot be completely discharged, which negatively affects the subsequent rewinding and other production processes. Therefore, it is necessary to propose an improvement.

### SUMMARY

The present disclosure relates to a round knife waste discharge mold for laser cutting which overcomes the deficiencies in the prior art.

In order to realize the above purposes, the round knife waste discharge mold provides the following technical solutions.

In one aspect of the invention, a knife waste discharge mold for laser cutting comprises a round knife mold, the round knife mold includes a body defining a rotating sleeve, the rotating sleeve having a circumferential surface and an axial direction, the rotating sleeve defining a plurality of air passages along the axial direction, a plurality of blocks protruding from the circumferential surface, each of the blocks having a blowing hole, and each of the air passages being connected to one of the blowing holes, an air intake sleeve positioned proximate to one end of the rotating sleeve, and an intake nozzle connected to the air intake sleeve and to the air passages.

In one embodiment, the body of the round knife mold is concavely provided with a plurality of mounting grooves, each of the mounting grooves corresponding to one of the blocks on the circumferential surface of the body.

In another embodiment, each of the blocks has a top and a bottom opposite the top, the bottom of each block is located in one of the mounting grooves, and the top of each block protrudes outwardly on the circumferential surface.

In yet another embodiment, each mounting groove is connected to one of the air passages.

In another embodiment, each block is spaced from a bottom of a corresponding mounting groove, and each block includes a hole that corresponds to one of the air passages.

In yet another embodiment, the body of the round knife mold has opposite ends and a mounting shaft projecting from each end, each of the mounting shafts includes a shoulder, and the air intake sleeve is located on the shoulder near an open end of the air passages.

In another embodiment, the air intake sleeve has an annular configuration and an inner end face, the inner end face being proximate to the shoulder of one of the shafts, and the inner end face has an air groove that is connected to the intake nozzle.

Compared with the existing technology, some of the advantages of the knife waste discharge mold include: the round knife waste discharge mold has a simple structure, the circumference or circumferential surface of the round knife mold is convex and extends with the product waste similar to the shape of the top of the block, the waste from the top of the material belt is in the shape of the top of the block and includes a number of blowing holes, the use of compressed air is blown through the system to blow out the waste, a variety of waste discharge methods to work together, and the overall improvement of the discharge of the waste material.

### BRIEF DESCRIPTION OF THE DRAWINGS

In order to more clearly illustrate the technical solutions in the embodiments of the utility model or the prior art, the following will briefly introduce the accompanying drawings that need to be used in the description of the embodiments or the prior art, and it will be obvious that the accompanying drawings in the following description are only some of the embodiments documented in the utility model, and that for the person of ordinary skill in the field, it will be possible to obtain other drawings in accordance with the drawings, without putting forth any creative labor. other accompanying drawings.

FIG. 1 shows a perspective view of an embodiment of a round knife waste discharge mold for a laser cutting process.

FIG. 2 shows an exploded perspective view of the round knife waste discharge mold illustrated in FIG. 1.

FIG. 3 shows a side view of the round knife waste discharge mold illustrated in FIG. 1.

FIG. 4 shows a cross-sectional end view of the round knife waste discharge mold illustrated in FIG. 1.

FIG. 5 shows a perspective view of the air intake sleeve of the round knife waste discharge mold illustrated in FIG. 1.

### DETAILED DESCRIPTION

The technical solutions in the embodiments are described in detail below in conjunction with the accompanying drawings. It is clear that the embodiments described herein are only exemplary of the various embodiments of the invention. Based on the described embodiments, other embodiments may be obtained by a person of ordinary skill in the art.

In the description herein, it is to be noted that the terms “center”, “top”, “bottom”, “left”, “right”, “vertical”, “horizontal”, “inside” and “outside” and the like indicate orientations or positional relationships based on those shown in the accompanying drawings, and are only intended to facilitate and simplify the description, and are not intended to indicate or imply that the device or element referred to must have a particular orientation, or be constructed and operated with a particular orientation, and therefore are not to be construed as a particular limitation. Furthermore, the terms “first”, “second” and “third” are used for descriptive purposes only and are not to be understood as indicating or implying relative importance.

It is to be noted that, unless otherwise expressly specified and limited, the terms “mounted”, “connected”, “connected” are to be understood in a broad sense. They may be interpreted to cover a fixed connection, a removable connection, or a connection in one piece; as well as a mechanical connection or an electrical connection; and also a direct connection or an indirect connection through an intermediary medium; and alternatively, it may be a connection within two elements. For a person of ordinary skill in the art, the specific meaning of the above terms can be understood in specific cases.

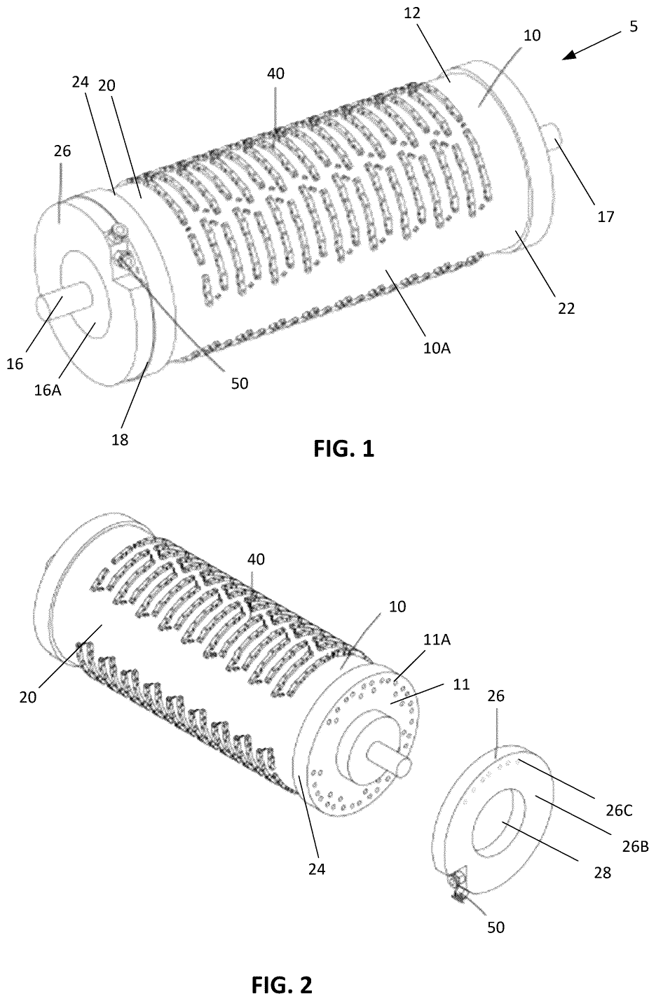

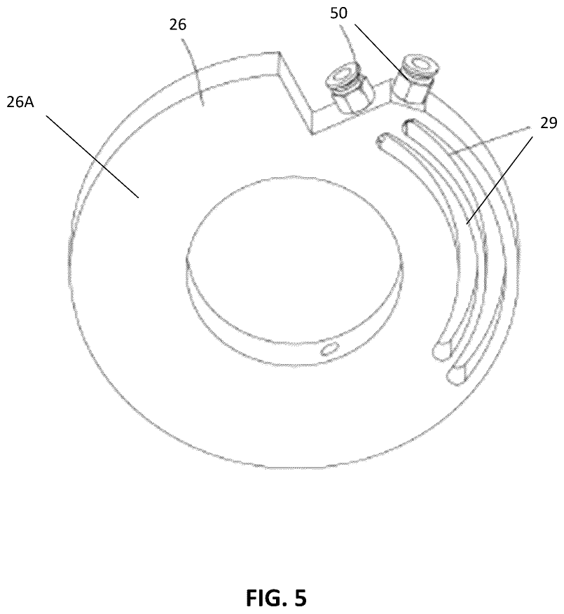

Referring to FIGS. 1 to 5, there is shown a round knife waste discharge mold 5 for laser cutting. The mold 5 has an overall cylindrical configuration and the shape of the mold 5 is referred to as being round or circular, which is indicative of the cross-sectional shape of the mold 5. In this embodiment, the mold 5 comprises a round knife mold 10 that has a number of profiled top blocks 30 protruding from its circumference or circumferential surface 12, and a number of air blow holes 32 are provided in the profiled top blocks 30. The terms circumference and circumferential surface are alternatively used herein. One end 22 of the round knife mold 10 is provided with a number of air channels 30 in its axial direction. The air channels 30 are connected to the corresponding blow holes 42. One end 24 of the round knife mold 10 is rotationally provided with an air inlet sleeve 26. The air inlet sleeve can be referred to alternatively as an air intake sleeve. An air inlet nozzle 50 is rotationally connected to the air channels 30 and is provided in the air inlet sleeve 26. The air inlet nozzle 50 can be referred to alternatively as an intake nozzle or an air intake nozzle.

In this technical solution, the round knife mold can directly use the existing structure, and in its circumferential surface is set with the top blocks 40 corresponding to the need to eliminate waste material. The top blocks 40 have a top 44 and a bottom 46 opposite to the top 44 (see FIG. 4). The contour and position of the top blocks 40 are determined according to the actual processing position of the product, the shape and size of the product and other parameters. The top blocks 40 are only in contact with the waste material so as to avoid damage to the product. Accordingly, there is a height difference between the top block 40 and the circumferential surface 12 of the round knife mold 10. When the laser cut sheet passes through the round knife mold 10, the profiling top blocks 40 will push out the waste material. At least one profiling top block 40 is set in the circumferential direction of the circumference or circumferential surface 12 of the round knife mold 10, which is used for circulating waste discharge in the direction of the sheet's row and diameter. When two or more profiling top blocks 40 are set in the circumferential direction of the circumferential surface 12 of the round knife mold 10, the spacing and the shape of the profiling top blocks 40 are the same or different, and at least one profiling top block 40 is set in the axial direction of the circumferential surface 12 of the round knife mold 10, which is used for the simultaneous discharge of the waste in the same direction of the sheet's width. When two or more profiling top blocks 40 are set in the axial direction of the circumference 12 of the round knife mold 10, the spacing and shape between the profiling top blocks 40 are the same or different.

Referring to FIG. 2, one end 11 of the round knife mold 10 has along its axial direction a number of blind holes 11A, which are connected to the air channels 30. In one implementation, during the round knife mold rotation process, the air inlet sleeve 26 does not rotate, which enables the air channels 30 to stay connected to the air inlet sleeve 26 of the air inlet nozzle50, which is connected through conventional air tubes to an external compressed air and other pressure media. As a result, the air supply is connected to the corresponding air channel 30 of the air holes 42 for providing an airflow for blowing out the waste material for the second time to ensure that the waste material is completely removed.

The round knife waste discharge mold 5 for laser cutting has a simple structure, and the circumference 12 of the round knife mold 10 has several top blocks 40 that are similarly sized to the product waste, so that the waste can be ejected from a material belt. At the same time, there are a number of blow holes 42 in the top blocks 40, so that compressed air can be used to blow out the waste, and a variety of waste discharge modes can work together to improve the effect of the discharge of the waste material.

Exemplarily, as shown in FIGS. 1 to 4, the round knife mold 10 has a number of mounting grooves 42 (see FIG. 4) concavely provided on the circumference 12 of the round knife mold 10 corresponding to the profiling top blocks 40. The bottom of each profiling top block 40 is embedded in the corresponding mounting groove 14, and the top of each profiling top block 40 protrudes from the circumference 12 of the round knife mold 10.

In this technical solution, each of the profiling top blocks 40 is embedded in one of the mounting grooves 14 by means of interference fit or the like, and each of the mounting grooves 12 can be a standard structure, such as a step groove, to limit the mounting depth of the profiling top block 40 and reduce the assembly difficulty.

Exemplarily, referring to FIGS. 1 through 4, the mounting groove 14 is connected to the corresponding airway 30.

In this technical solution, multiple profiling top blocks 40 are provided in the same round knife mold 10, and the same type of profiling top blocks 40 are using the compressed air that is connected between the blocks 40 through the same air inlet. Different profiling top blocks 40 pass through the same air inlet or different compressed air is connected to the same air nozzle, and the air channels 30 can be set up in multiple layers from the outside to the inside to avoid conflicts between different air inlets. Interconnected, multi-layer air channels 30 use the same air inlet or set corresponding air inlets separately, and each layer of air inlets reaches the round knife mold 10.

In one embodiment, the center of gravity distance is the same, and a number of air channels are set up in the same layer of the mold 10. The spacing between adjacent air channels 30 in the same layer can be either the same or different. Each mounting groove 14 is connected to an air channel 30 or connected to a number of air channels 30 in the same layer at the same time. The circumferential length of the top blocks 40 corresponds to the area of a larger waste, and the top blocks 40 can be set up in the direction of the length of a plurality of blowing holes 42. The corresponding mounting groove 14 for a block 40 is connected to a plurality of air channels 30 in the same layer. The air inlet nozzle 50 is connected to compressed air with higher pressure to enhance the effect of waste discharge, while for the smaller top blocks 40, i.e., corresponding to waste material with smaller area, a single blow hole 42 can be provided in the top block 40 and the single blow hole 42 is connected to a single air channel 30. As a result, the air inlet nozzle 50 is connected to compressed air with a lower pressure to minimize the waste.

Exemplarily, as shown in FIG. 4, a bottom portion of the profiling top block 40 is spaced from a bottom portion of the mounting slot 14. The airway 30 is equipped with a clearance groove that corresponds to the corresponding airway 30.

In this technical solution, the depth of the mounting groove 14 is at least connected to the corresponding layer of the air channel 30, the air channel 30 is connected to the corresponding blow hole 42 in the corresponding top block 40 through the mounting groove 14. The top block 40 is spaced from the bottom of the corresponding mounting groove 14, and each of the mounting grooves 14 is connected to all the blow holes 42 in the corresponding top block 40 at the same time. The bottom of the top block 40 is equipped with a blow hole 42 that is connected to the corresponding air channel 30. The corresponding avoidance slots in the airway avoid blocking/interfering with the flow of compressed air in the airway.

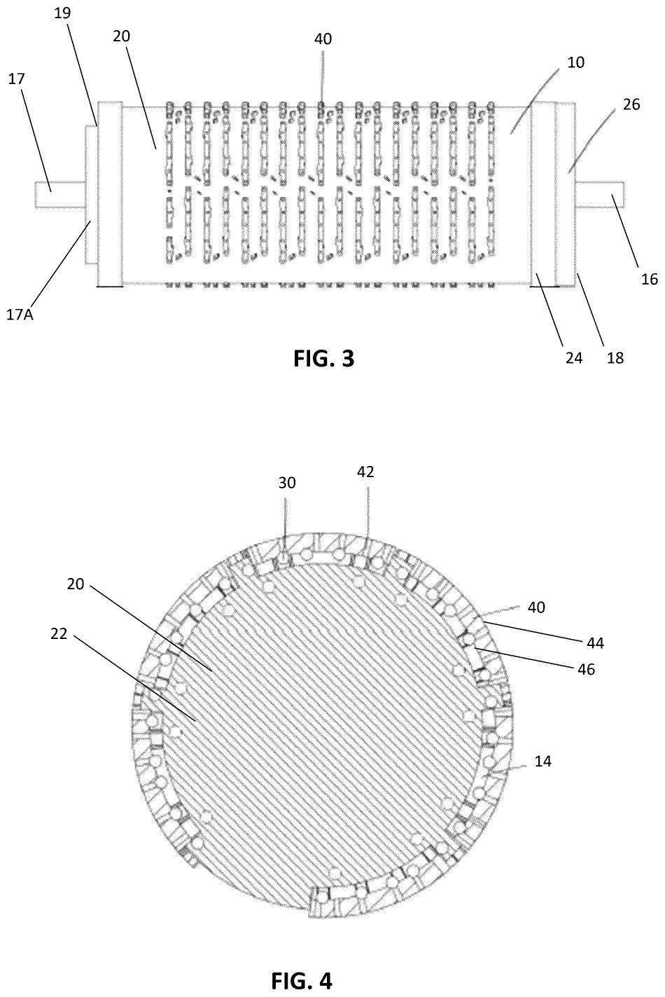

Exemplarily, as shown in FIGS. 1 and 3, mounting shafts 16 and 17 protrude from opposite ends 18 and 19, respectively, of the round knife mold 10.

The mounting shafts 16 and 17 are each provided with a shoulder, such as shoulder 16A in FIG. 1 and shoulder 17A in FIG. 3, and the air inlet sleeve 26 is placed on the shoulder 16A near the opening of the air passage 30, against which the air inlet sleeve 26 is placed.

A through-hole 28 is provided in the shoulder of the inlet sleeve 26 for connecting the air passage 30 (see FIG. 2).

In this technical solution, the mounting shaft 16 and the shoulder 16A can use the structure of existing technology, the mounting shaft 16A can be directly set up in the existing equipment. The air inlet sleeve 26 through the bearings and other rotating set in the corresponding shoulder, do not follow the rotation of the round knife mold 10 together. The airway system is connected to the air inlet sleeve 26 of the air inlet nozzle 50, and the air inlet nozzle 50 is connected through the conventional air tubes to an external source of compressed air and/or other pressure media, and is connected to the corresponding air blowing hole 42. The airflow is blown out from the corresponding air holes 42 to carry out or perform secondary waste removal to ensure that the waste material is completely eliminated.

Exemplarily, as shown in FIGS. 1 to 5, the air inlet sleeve 26 is an annular structure, and air grooves 29 are provided on the end face 26A of the inner side close to the shoulder 16A of the shaft 16 to connect to the air inlet nozzles 50. In this embodiment, the air grooves 29 are curved, and each air inlet nozzle 50 corresponds to one of the air grooves 29, which is provided in correspondence with the air channels 30 of the multi-layer mold 10, respectively.

In this technical solution, the air inlet sleeve 26 is a ring-like structure, and its inner ring is rotationally set on the corresponding shaft shoulder 16A through bearings and other conventional structures (not shown), and it is adjustably fixed to an external frame through holes. For example, a number of threaded blind holes 26C are set on the outer end face 26B (see FIG. 2) of the air inlet sleeve 26 (which is staggered from the air grooves 29), and the external frame is set with curved long holes. The air inlet sleeve 26 is fixed by bolts in an adjustable manner, so as to regulate the circumferential position of the air inlet sleeve 26 with the round knife mold 10. Thus, adjustment of the circumferential position of the air groove 29 and the round knife mold 10, the round knife mold rotation process, and the corresponding airway rotation to the position of the air grooves 29 can be performed in order to connect to the corresponding air inlet nozzle 50 and allow for the introduction of compressed air, so as to adjust the blowing holes 42 in the circumferential direction of the round knife mold blowing position, to achieve the direction of the blowing air.

In summary, the round knife waste discharge mold for laser cutting has a simple structure, in which the circumferential surface of the round knife mold 10 is convex and extended with the product waste similar to the shape of the top blocks 40. The waste from the top of the material belt, is gathered, and the top blocks 40 are provided with a number of blow holes 42 through which compressed air is blown to blow out the waste. A variety of waste discharge methods to work together, to improve the effect of the discharge of waste material.

It should be noted that, as used herein, the terms “including”, “comprising”, or any other variant thereof, are intended to cover nonexclusive inclusion, such that a process, method, article, or apparatus that comprises a set of elements includes not only those elements but also other elements that are not expressly listed, or that are inherent to such process, method, article or apparatus. Without further limitation, the fact that an element is defined by the phrase “includes a . . . ” does not preclude the existence of additional identical elements in the process, method, article or apparatus in which the element is included.

What is claimed is:

1. A knife waste discharge mold for laser cutting, comprising:
a round knife mold, the round knife mold including:
a body defining a rotating sleeve, the rotating sleeve having a circumferential surface and an axial direction, the rotating sleeve defining a plurality of air passages along the axial direction;
a plurality of blocks protruding from the circumferential surface, each of the blocks having a blowing hole, and each of the air passages being connected to one of the blowing holes;
an air intake sleeve positioned proximate to one end of the rotating sleeve; and
an intake nozzle connected to the air intake sleeve and to the air passages.

2. The knife waste discharge mold of claim 1, wherein the body of the round knife mold is concavely provided with a plurality of mounting grooves, each of the mounting grooves corresponding to one of the blocks on the circumferential surface of the body.

3. The knife waste discharge mold of claim 2, wherein each of the blocks has a top and a bottom opposite the top, the bottom of each block is located in one of the mounting grooves, and the top of each block protrudes outwardly on the circumferential surface.

4. The knife waste discharge mold of claim 2, wherein each mounting groove is connected to one of the air passages.

5. The knife waste discharge mold of claim 2, wherein each block is spaced from a bottom of a corresponding mounting groove, and each block includes a hole that corresponds to one of the air passages.

6. The knife waste discharge mold of claim 2, wherein the body of the round knife mold has opposite ends and a mounting shaft projecting from each end, each of the mounting shafts includes a shoulder, and the air intake sleeve is located on the shoulder near an open end of the air passages.

7. The knife waste discharge mold of claim 6, wherein the air intake sleeve has an annular configuration and an inner end face, the inner end face being proximate to the shoulder of one of the shafts, and the inner end face has an air groove that is connected to the intake nozzle.
